(19) United States
(12) Patent Application Publication
(10) Pub. No.: US 2012/0312176 A1
(43) Pub. Date: Dec. 13, 2012

(54) Hand Held Fruit Juicer

(76) Inventors: Alessandro Ippolito, Temple Terrace, FL (US); Naveed Mohammad, Miami, FL (US)

(21) Appl. No.: 13/157,211

(22) Filed: Jun. 9, 2011

(51) Int. Cl. A23N 1/00

(52) U.S. Cl. 99/509

(57) ABSTRACT

A fruit juicer (10) having a juicing body (52) and a base (54). The juicing body (10) has a tube (30) with a distal end (12), a downstream-facing surface (18) at the distal end (12), and a tube outer surface (36); a cutting element (20) disposed at the distal end (12) having a cutting element downstream end (24) disposed flush with or upstream of the downstream-facing surface (18); a raised thread (40) raised radially outward from the tube outer surface (36); an opening (28) in the tube (30) having at least a portion disposed between the distal end (12) and the raised thread (40); a flange (44); and a relief section (42) between the raised thread (40) and the flange (44). The base (54) is connected to the juicing body (52) proximate the flange (44), and has a base wall (56) defining an inner chamber (68) in fluid communication with the opening (28) and configured to contain liquid. The base wall (56) is rotably fixed with respect to the distal end (12) and has an outer grip surface (58) at least part of which is disposed radially outward of the tube outer surface (36).

### FIELD OF THE INVENTION

This invention relates to a device for extracting juice from a fruit. Specifically, this invention relates to a hand-held tool that readily pierces the rind of the fruit and extracts the juice, and which has the capacity to store the juice.

### BACKGROUND OF THE INVENTION

Extracting juice efficiently directly from a fruit immediately prior to using the juice provides the freshest juice possible. As a result hand held tools have been devised to aid in the extraction. Such tools usually have a main body with a downstream end with cutting elements that cut into the rind of the fruit when the cutting elements are pressed and rotated into the fruit. Once through the main body of the tool is inside the fruit the fruit is squeezed from outside and the juice travels through openings in the main body where it is directed out of the fruit via a passage. Some tools include raised ridges on the main body that enter the fruit and aid in breaking the fibers inside the fruit as the tool and ridges are rotated with respect to the fruit. Breaking the fibers from the inside supplements the squeezing of the fruit to extract the juice.

However, with existing tools the extraction process can be physically challenging, particularly for those with wet hands or reduced manual dexterity. In addition, such tools may have sharp cutting surfaces that may pose a safety hazard for the user if the user inadvertently contacts a cutting element when applying force to the tool, particularly at the initiation of the extraction process. Further, the extraction process is limited to extracting juice from only a single fruit at a time before having to remove the extracted juice from the fruit juicer, or if the single fruit produces sufficient juice the extraction process must be interrupted to remove the extracted juice from the fruit juicer before continuing with the extraction, due to limited fluid storage capacity of the tool. Consequently, there is room for improvement in the art.

### BRIEF DESCRIPTION OF THE INVENTION

One embodiment of the present invention is directed toward a fruit juicer having a juicing body and a base. The juicing body has a tube with a distal end, a downstream-facing surface at the distal end, and a tube wall; a cutting element disposed at the distal end having a cutting element downstream-end disposed flush with or upstream of the downstream-facing surface; a thread raised radially outward from the tube wall; an opening in the tube wall having at least a portion disposed between the distal end and the thread; a flange; and a relief section between the thread and the flange. The base is connected to the juicing body proximate the flange, and has a base wall defining an inner chamber in fluid communication with the opening and configured to contain liquid. The base wall is rotably fixed with respect to the distal end and has an outer grip surface at least part of which is disposed radially outward of the tube wall.

A second embodiment of the present invention is directed toward a fruit juicer having: a hollow juicing body; alternating downstream-facing cutting and non-cutting regions disposed on an annular leading edge of the juicing body, wherein no part of the cutting region extends downstream past the non-cutting region; a juicing body opening through the juicing body disposed upstream of the leading edge; a helical thread raised from a juicing body outer surface and extending upstream of the juicing body opening; a relief region of the juicing body outer surface upstream of the helical thread; a flange raised from the juicing body outer surface and disposed upstream of the relief region; and a gripping surface defined by the juicing body outer surface upstream of the flange and rotably fixed with respect to the juicing body leading edge, wherein a smallest diameter of the gripping surface is greater than a largest diameter of the juicing body downstream of the flange.

### BRIEF DESCRIPTION OF THE DRAWINGS

A more particular description of the invention briefly described above will be rendered by reference to specific embodiments thereof that are illustrated in the appended drawings. Understanding that these drawings depict only typical embodiments of the invention and are not therefore to be considered to be limiting of its scope, exemplary embodiments of the invention will be described and explained with additional specificity and detail through the use of the accompanying drawings in which:

FIG. 1 illustrates a side view of an embodiment of a hand held fruit juicer.

FIG. 2 illustrates a cross-section of the hand held fruit juicer of FIG. 1.

FIG. 3 illustrates a side view of an alternate embodiment of the hand held fruit juicer of FIG. 1.

FIG. 4 illustrates a side view of another embodiment of a hand held fruit juicer.

FIG. 5 illustrates an upstream end view of another embodiment of a hand held fruit juicer.

### DETAILED DESCRIPTION OF THE INVENTION

The present inventors have devised an innovative fruit juicer that is safer to operate than existing fruit juicers, requires less force from an operator to accomplish a juicing action, and has a built in capacity to store any juice that is extracted. Increased safety from the innovative cutting edge reduces a chance of injury. Such injury is increased when using a tool such as a fruit juicer in particular because such use often occurs when the user's hands are wet, and thus have reduced grip and associated control of the tool. Likewise, wet hands, or hands of those with limited dexterity, may not be able to deliver the force required of conventional fruit juicers to accomplish the juicing action required to break the fibers inside the fruit to extract the fruit. However, the fruit juicer disclosed herein is constructed to permit greater leverage to a user, thus reducing the amount of force required to accomplish the juicing action. In an embodiment the juicer may be configured to stand on end, and thus allow the user to brace the juicer against a horizontal surface such as a table to gain aid in the extraction process. Finally, conventional tools may be intended to extract juice from a single fruit and thus provide only a small passage for extracted juice to flow through on its way to a remote storage unit, or a straw for direct consumption. The present fruit juicer provides a storage unit with an optional dispenser that enables the user to extract the juice from several pieces of fruit without any need to empty the fruit juicer.

Reference will now be made in detail to the embodiments consistent with the invention, examples of which are illustrated in the accompanying drawings. Wherever possible, the same reference numerals used throughout the drawings refer to the same or like parts.

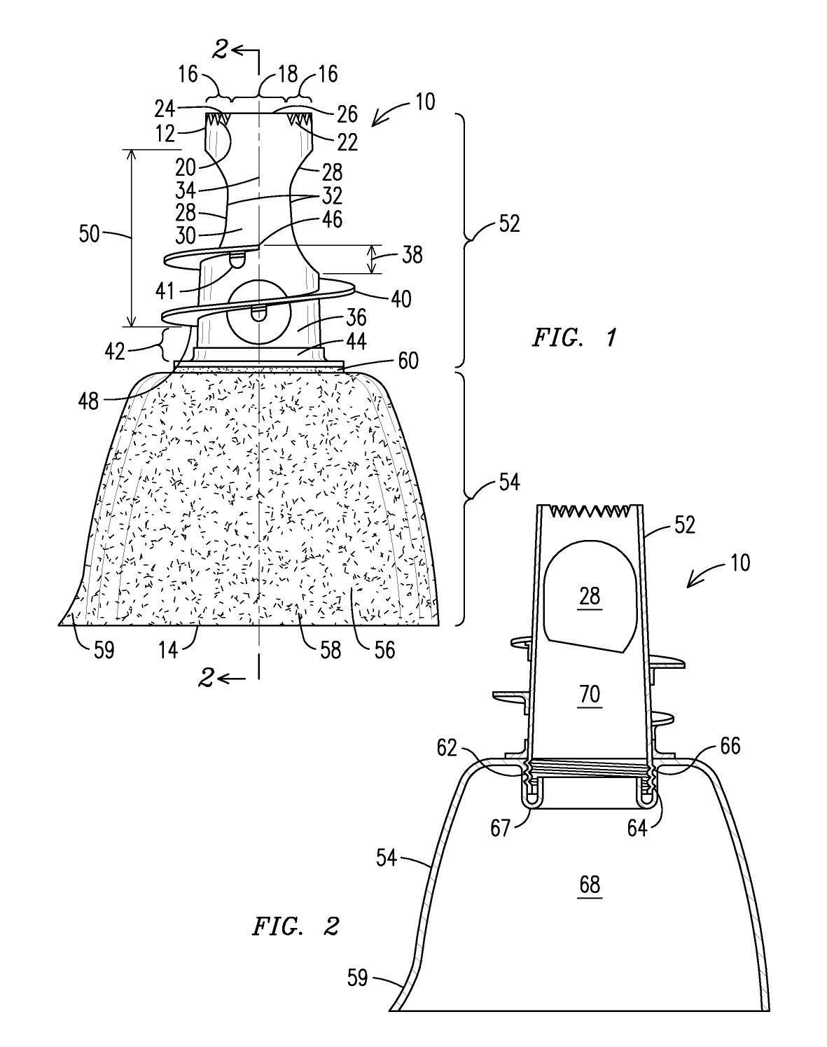

FIG. 1 shows an embodiment of the fruit juicer 10 of the present invention. The fruit juicer has a downstream end 12 and an upstream end 14. Disposed at the downstream end 12 (a.k.a. distal end) are alternating cutting regions 16 and non cutting regions 18. In the embodiment shown the cutting region has a plurality of cutting elements 20 which are teeth 22. One of ordinary skill in the art would appreciate that any number of alternate cutting elements could be employed, including a circumferentially oriented sharp edge similar to a knife blade. Although a plurality of cutting regions 16 are shown, more or fewer may be utilized. A single cutting region 16 comprising a single cutting element 20 may be used as well. A cutting element downstream end 24 may be disposed flush with a downstream-facing non-cutting region surface 26, or may be disposed upstream of the non-cutting region surface 26. Since the cutting element downstream end 24 does not extend downstream past the non-cutting region surface 26, a user is better protected from cuts. Specifically, if the downstream end 12 were to inadvertently contact a user when the user is applying force to the fruit juicer 10, the non-cutting region surface 26 will either contact the skin at the same time or sooner than the cutting element downstream end 24 will. Being sufficiently blunt the non-cutting region surface 26 will not penetrate the user's skin, and by virtue of its position with respect to the cutting element downstream end 24 it will prevent the cutting element 20 from penetrating the user's skin as well. Consequently, a chance of user injury is reduced with this innovative downstream end 12 design.

Upstream of the downstream end 12 is at least one opening 28 through a hollow main body 30 of the fruit juicer. In an embodiment the main body 30 may be shaped like a tube. However, the bulk of the main body 30 need not be entirely annular, but may be any shape that aids the juicing process. In the embodiment shown there are two openings 28. The openings are disposed opposite each other, and are large relative to the circumference of the main body 30 at that point. The openings 28 need not be limited to a single or dual openings, and need not be directly opposite each other; they may be staggered circumferentially and/or axially. In an embodiment a single opening 28 may have a minimum size as defined by a circumference of the main body 30 where the opening 28 is disposed. Since an opening 28 may be circular, or oval, or comprise an uneven shape, it is important that the opening be sufficiently “wide” such that fibers can extrude or “bulge” radially inwardly into the hole. As used herein, when referring to the size of an opening, reference will be made to the main body material removed to form the opening, where the removed material retains a shape it possessed prior to being removed. When referring to a width of the removed material, width refers to an arc length of the removed material. An arc length of the removed material is a segment of the circumference of the main body 30 that is removed when the material is removed, since the removed material was originally part of the main body 30. If one envisions the removed material placed back in the opening 28 it was removed to create, the arc-length of the removed material may vary along a longitudinal axis 34 of the fruit juicer 10. The widest part of the removed material is the location where the arc length of the removed material is greatest. Stated another way, it is the location where, in a cross section of the main body 30 perpendicular to the longitudinal axis 34, the least amount of main body material remains in the circumference. In an embodiment the greatest (a.k.a. the maximum) width of the removed material may be at least approximately 20% of what the circumference of the main body was at that same point along the longitudinal axis 34 of the fruit juicer 10 prior to the formation of the hole. For example, if the circumference of a main body at a given point along the longitudinal axis 34 prior to removing any material is “x”, and the opening to be formed is “widest” at that given point along the longitudinal axis 34, then the removed material will remove at least approximately 20% of the material that forms the circumference at that given point. Stated another way, at the point where the opening 28 is widest, when compared to a cross section of the main body 28 taken at that point prior to the formation of the hole, a cross section taken after formation of the hole will form an open circle, similar to a “C” shape, and the arc length of the “C” shape will be no more than 80% of the original circumference. The removed material at that point will have an arc length of at least approximately 20% of the original circumference. The proportion of material remaining in the cross section for any given single hole need not be exactly 80% or below. Any proportion that, at a minimum, retains structural stability of the fruit juicer 10 while providing a maximum amount of opening 28 through which the juice may flow is considered acceptable.

The above holds true for each opening whether or not openings 28 overlap axially. In the embodiment shown, where there are two openings 28 disposed directly opposite each other, each opening would remove at least 20% of the circumference of the main body material, for a total of 40% of the circumference removed. The proportion of material remaining in the cross section for any given single hole need not be exactly 80% or below. In instances where a perimeter of a first opening 28 axially overlaps the largest arc length of a second opening 28 but the openings are not disposed directly opposite each other, the percentage of main body material in a cross section taken at the largest arc length of the second opening 28 would be subject to a shape of the opening and other design considerations. However, the percentage of main body material remaining would be less than 80% of the circumference of the main body at the largest arc length of the second opening, less whatever percentage is removed by the overlapping portion of the first opening.

In operation, when the fruit juicer 10 is rotated inside the fruit, fiber-breaking edges 32 will help break the fibers inside the fruit, making it easier to extract the juice. This fiber breaking may result from the fiber breaking edge 32 essentially scraping or pressing against fibers as they rotate with respect to one another. Additionally, this breaking may result as the fiber breaking edge 32 presses against a portion of the fibers that have protruded into the opening 28 as a result of pressure within the fibers expanding the fibers into the opening 28, and/or pressure from the user's squeezing action which pushes fibers into the opening 28. A fiber-breaking edge 32 as used herein is any portion of a perimeter of opening 28 that breaks fibers as the opening 28 is rotated in the fruit. As juice is extracted the fruit is gradually squeezed further, which reduces the diameter of the fruit. As a result, the fiber-breaking edges 32 contact and break fibers that were originally radially outward of the fiber-breaking edges 32, but have moved inward as a result of the squeezing opening juicing.

Also disposed on an outer surface 36 of the main body 30 are a raised thread 40 fixed in position with respect to the main body 30, a relief region 42, and a raised flange 44 also fixed in position with respect to the main body 30. In operation as the fruit juicer 10 is being inserted into the fruit a leading edge 46 of the raised thread traverses the rind of the fruit. Continued rotation of the fruit juicer 10 advances the fruit juicer 10 into the fruit, and the raised thread 40 aids the user in advancing the fruit juicer 10 into the fruit. Once a trailing edge 48 of the raised thread 40 traverses the rind and is inside the fruit, the rind is then disposed in relief region 42. The raised thread 40 and the flange 44 trap the rind in the relief region 42. As the fruit juicer 10 is further rotated the raised thread 40 breaks the fibers inside the fruit similar to how the fiber-breaking edge 32 does. As a result the raised thread 40 needs to have a pitch that allows it to traverse the rind, and must be structurally sufficient to break the fibers inside the fruit as it is rotated yet remain intact. In an embodiment the raised thread 40 may be in a helical form, however one skilled in the art would appreciate that other forms would be acceptable. The raised thread leading edge 46 may be tapered to ease initial contact with the rind.

Raised thread 40 may be formed integral to the main body 30, or may be formed separately and joined. For example, in an embodiment where the main body 30 is a one-piece plastic mold the raised thread 40 may be integrally formed as part of the main body 30 during formation of the main body 30. In an embodiment where, for example, the main body 30 and the raised thread 40 are stainless steel, the main body 30 and the raised thread 40 may be discrete components that are separately formed and subsequently attached to the main body 30 by way of raised thread connectors 41. The raised thread connectors may simply be welds, or any other connector known to those of ordinary skill in the art.

An opening 28 and the raised thread 40 may abut axially or even overlap 38 axially to form an axially continuous region 50 with different fiber-breaking mechanisms. This will ensure a maximum amount of fibers inside the fruit make contact with either a fiber-breaking edge 32 or the raised thread 40 and is mechanically broken during the rotation of the juicing action, without missing any of the fibers. Either abutting axially or having overlap 38 ensures there is no region between the fiber-breaking edge 32 and the raised thread 40 where fruit fibers may not be broken and juice extracted. The main body 30 may further be tapered toward a downstream end 12 in order to ensure a tight fit between the rind and the main body outer surface 36, which may reduce or eliminate juice leakage. Optionally, a strainer (not shown) may be disposed in the main body 30 at a location upstream of any opening 28 to prevent any seeds and/or fibers etc from being delivered to the user.

A first part of the fruit juicer 10 having all of the elements disclosed from the flange 44 downstream may be considered the juicing body 52. A second part of the juicing body upstream of the flange 44 may be considered a base 54. The juicing body 52 may be formed as one with the base 54, such as by a molding process that forms both as a monolith. Alternately, they may be formed separately and joined together, either permanently as by welding or gluing, or releasably, such as by threaded connections (discussed below) or by snapping together etc.

The base 54 comprises a base wall 56 that defines a chamber (not shown) inside the base 54. The chamber is in fluid communication with the opening 28 within the main body 30, such that any fluid that enters the main body 30 through the opening 28 or the downstream end 12 may flow into the chamber. The base wall 56 defines on a radially outer side a gripping surface 58. At least a part of the gripping surface is disposed radially outward of a most radially-outward main body outer surface 36. In the embodiment of FIG. 1, the base wall 56 may have an annular shape. During juicing the user grips the gripping surface 58 and imparts a rotation to the entire fruit juicer 10 by rotating the gripping surface 58. Having at least a portion of the gripping surface 58 radially enlarged provides the user with what is essentially a greater leverage action about the longitudinal axis 34 of the fruit juicer 10, and this leverage reduces the force required to rotate the fruit juicer 10. This may be particularly beneficial when juicing fruit since the fruit juicer 10 may be used when a user's hands are wet, and friction alone may not be sufficient to enable the user to repeatedly rotate the fruit juicer 10 without tiring. Further, the gripping surface 58 itself may be textured to increase grip. As a result rotation being imparted at the base 54, if the fruit juicer 10 is a two piece construction the base 54 must be connected to the juicing body 52 in a manner that is structurally sufficient to rotably fix the base 54 with respect to the juicing body 52 to transmit the rotational force from the base 54 all the way through the fruit juicer 10 to the downstream end 12. Such a bond 60 may be an adhesive bond, or a welded bond etc. The base wall 56 may further include a base lip 59, which is useful to facilitate smooth and clean pouring of extracted juice from the base 54.

As shown in FIG. 2, which is a cross section of the fruit juicer 10 of FIG. 1, the base 54 may be attached to the juicing body 52 through a threaded connection 62. For example, the juicing body 52 may have male threads 64 and the base 54 may have female threads 66 to receive the male threads 64. The male threads 64 may be right handed or left handed threads, depending on the design of the fruit juicer. For example, if the juicer is designed to be used by those imparting a right hand rotation to the fruit juicer 10, then right hand male threads 64 may be used since this will help the juicing body 52 and the base 54 remain secured to each other. The base 54 may also have a folded lip 67. The folded lip 67 may be disposed such that when assembled the male threads 64 from the juicing body 52 will be shielded. In this manner the folded lip 67 may protect a user from contacting the male threads 64 during handling of the fruit juicer 10. Preventing this contact may prevent injury resulting from any sharp edges that may be present on or about the male threads 64.

Also visible in FIG. 2 is chamber 68. In operation opening 28, juicing body hollow interior 70, and the chamber 68 are in fluid communication with each other. Any juice extracted from the fruit enters the juicing body hollow interior 70 after passing through the opening 28. What happens to the extracted juice next depends on the orientation of the fruit juicer 10. If the downstream end 12 is oriented upright, then the extracted juice will simply drain from the juicing body hollow interior 70 into the chamber 68. If the downstream end 12 is oriented downward, then the extracted juice may collect in the juicing body hollow interior 70. As more juice is extracted the capacity of the juicing body hollow interior 70 may not be sufficient, and the extracted juice may flow into the chamber 68. The user may continue to juice until all the juice from the fruit is extracted, or the user may drain the extracted juice periodically prior to extracting all the juice from the fruit.

As shown in FIG. 3, the unique design of the fruit juicer 10 disclosed herein permits yet another option. In the embodiment shown in FIG. 3, the chamber is enclosed. In this embodiment the enclosed chamber 74 is enclosed with a detachable lid 72. With a fruit juicer 10 having an enclosed chamber 74, the user may orient the fruit juicer 10 such that the extracted juice enters the enclosed chamber 74, and may extract juice from more than one fruit before emptying the extracted juice from the fruit juicer 10. (A piece of fruit is represented by the dotted line.) The extracted juice will simply accumulate in the enclosed chamber 74 until the user wishes to remove the extracted juice, which is easily accomplished by several different ways, including: removing the fruit juicer 10 from the fruit and draining the extracted juice out the downstream end; leaving the fruit on the end to act as a plug for the downstream end 12, removing the lid 72, and pouring the extracted juice out of the chamber 68; or detaching the base 54 from the juicing body 52 and using the base as the vessel to carry the extracted juice. In order to make it easy for a user to know how much extracted juice has accumulated, the juicing body 52 and/or the base 54 may be made of translucent or transparent material.

In addition to enabling storage of extracted juice, an enclosed chamber 74 also provides a pressure surface 76. In operation, in order to insert the downstream end 12 into the fruit the user must press the fruit juicer 10 into the fruit. Typically this happens by applying force to the upstream end 14. Without a lid 72 or otherwise enclosed end wall, the force is applied to an upstream edge of the base wall 56. As a result the force on the user's palm is concentrated in, for instance, a thin ring. If a fruit is particularly difficult to penetrate, or after repeated juicing, this concentration of force on the user's palm may begin to irritate the user's palm. However, with the fruit juicer 10 design disclosed herein, the force would be spread out over a much greater surface area of the palm. This would enable the user to repeatedly juice fruit without irritation to the surface of the palm.

The pressure surface 76 may be configured such that when the fruit juicer 10 is placed on a horizontal surface the fruit juicer 10 is held in a position, such as upright. In an embodiment the pressure surface may be flat, such as is shown in FIG. 3. However, the surface need not be flat, but may have, for example, a gentle, rounded shape with a flat surface etc. Any shape may be used that will reduce palm irritation and/or permit the fruit juicer 10 to be held in a particular orientation, such as upright.

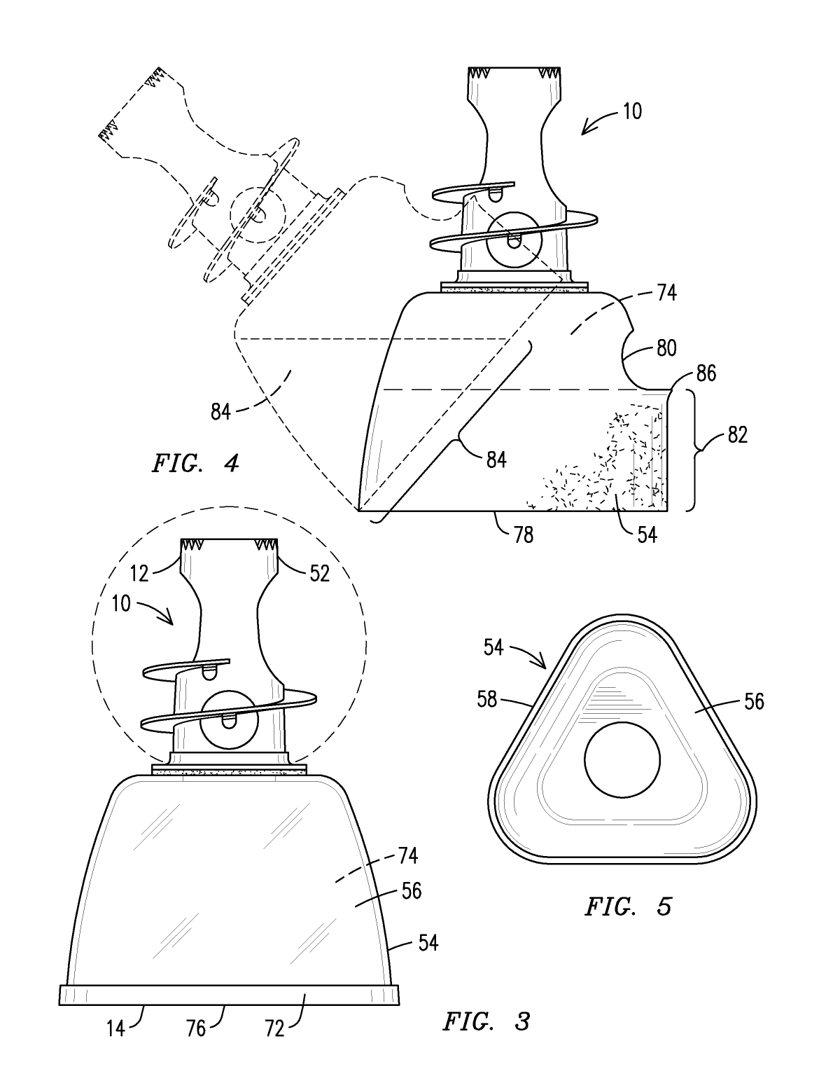

In an embodiment shown in FIG. 4, the fruit juicer 10 may have an enclosed chamber 74 where the chamber is enclosed with an integral base end wall 78. In such an embodiment the enclosed chamber 74 may be entirely enclosed and any extracted juice may be drained from the fruit juicer 10 by removing any fruit from the downstream end 12 and pouring it out. Alternately, the enclosed chamber 74 may have a base opening 80 formed through the base wall 56. In such an embodiment, extracted juice may accumulate in a first reservoir 82 that forms below the base opening 80 when the fruit juicer 10 is oriented upright. In this case repeated juicing may be accomplished simply by placing the fruit juicer 10 upright on a horizontal surface (or equivalent) and juicing a succession of fruits. Extracted juice will accumulate in the first reservoir 82. At the user's convenience the extracted juice may be left in the first reservoir 82, or may be used at will.

In a variation of this technique, and as shown in phantom in FIG. 4, the user may hold the fruit juicer 10 an orientation closer to (but not quite) horizontal with the base opening 80 oriented upward, and rotate the fruit but not the fruit juicer 10 during the extraction process. In this case a second reservoir 84 exists under the base opening 80 and extracted juice may flow into the enclosed chamber 74 and be drained at the convenience of the user. A base opening lip 86 may be formed at any location in the perimeter of the base opening 80 to facilitate pouring extracted juice from the fruit juicer 10.

FIG. 5 shows an end view from upstream of another embodiment of the fruit juicer 10 having an open upstream end. In this embodiment the base wall 56 may not have an annular cross section, but may instead undulate. Since the gripping surface 58 on the base wall 56 will be gripped by a user's hand, the base wall 56 can be ergonomically shaped to fit a hand more intimately than would an annular base wall. In the embodiment shown the base wall 56 may have alternating flat and curved regions, but one or ordinary skill in the art would appreciate that many contours may be used that will enable a grip better than would an annular shape. When the base wall 56 is of a different contour, physical interference between the base wall 56 and the user's hand will improve the user's ability to rotate the fruit juicer 10. This provides benefit for those with limited hand strength, or those whose hand may tire after repeated juicing.

The juicing body 52 and base may be made of any material appropriate for contact with fruit juice. Particular examples of suitable material include plastics, food grade PVC, stainless steels, ceramics, china, clay, or other food grade materials. The juicing body 52 and base 54 may or may not be made of the same material as each other. Any combination of materials that are compatible with each other for use in the fruit juicer 10, with fruit juice, and structurally sufficient is acceptable.

It has been shown that the unique fruit juicer disclosed herein is simple to manufacture and easy to use, but provides improved safety, requires less physical strength, and offers convenient storage and dispensing, while also enabling a user to extract the most juice from a fruit. As a result this juicer represents an improvement in the art.

While the invention has been described with reference to various exemplary embodiments, it will be understood by those skilled in the art that various changes, omissions and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

What is claimed is:

1. A fruit juicer, comprising:
a juicing body comprising:
a tube comprising a distal end, a downstream-facing surface at the distal end, and a tube outer surface;
a cutting element disposed at the distal end comprising a cutting element downstream-end that is disposed flush with or upstream of the downstream-facing surface;
a thread raised radially outward from the tube outer surface;
an opening in the tube comprising at least a portion disposed between the distal end and the raised thread;
a flange; and
a relief section between the raised thread and the flange; and
a base connected to the juicing body proximate the flange, comprising a base wall defining an inner chamber in fluid communication with the opening and configured to contain liquid, the base wall rotably fixed with respect to the distal end and comprising an outer grip surface at least part of which is disposed radially outward of the tube outer surface.

2. The fruit juicer of claim 1, comprising a plurality of groups each comprising a plurality of cutting elements, wherein each group is separated by downstream-facing surfaces devoid of cutting elements.

3. The fruit juicer of claim 1, an arc length of tube material removed to form the opening at a widest point of the removed tube material is greater than twenty percent of a circumference of the tube at the center of the opening.

4. The fruit juicer of claim 3, wherein the openings in the tube are disposed opposite each other.

5. The fruit juicer of claim 1, wherein the raised thread comprises a helical shape.

6. The fruit juicer of claim 1, wherein the base wall tapers radially outward away from the juicing body.

7. The fruit juicer of claim 1, wherein the tube and raised thread are formed integrally.

8. The fruit juicer of claim 1, wherein the tube and raised thread are discrete component connected to each other via raised a thread connector.

9. The fruit juicer of claim 1, wherein the base is enclosed.

10. The fruit juicer of claim 9, wherein the base comprises a base lid that fits onto the base wall to enclose the inner chamber.

11. The fruit juicer of claim 9, wherein the base comprises a base opening through the base wall such that a reservoir is formed inside the base below the base opening when the distal end is horizontal with or above the base.

12. The fruit juicer of claim 1, wherein the base comprises a contact surface that holds the fruit juicer in an upright position when the contact surface is placed on a horizontal surface.

13. The fruit juicer of claim 1, wherein the juicing body and the base are detachable from each other.

14. A fruit juicer, comprising:
a hollow juicing body;
alternating downstream-facing cutting and non-cutting regions disposed on an annular leading edge of the juicing body, wherein no part of the cutting region extends downstream past the non-cutting region;
a juicing body opening through the juicing body disposed upstream of the leading edge;
a helical thread raised from a juicing body outer surface and extending upstream of the juicing body opening;
a relief region of the juicing body outer surface upstream of the raised thread;
a flange raised from the juicing body outer surface and disposed upstream of the relief region; and
a gripping surface defined by the juicing body outer surface upstream of the flange and rotably fixed with respect to the juicing body leading edge, wherein a smallest diameter of the gripping surface is greater than a largest diameter of the juicing body downstream of the flange.

15. The fruit juicer of claim 14, wherein the juicing body opening defines a fiber-breaking edge configured to break fruit fibers when rotated within a fruit.

16. The fruit juicer of claim 14, wherein the fiber-breaking edge and the raised thread abut or overlap axially to form an axially continuous region of fiber breaking mechanisms.

17. The fruit juicer of claim 14, wherein a circumference of the juicing body upstream of the flange comprises an undulating shape.

18. The fruit juicer of claim 14, wherein an upstream end of the juicing body is enclosed.

19. The fruit juicer of claim 18, comprising a second opening through the gripping surface.

20. The fruit juicer of claim 19, wherein the second opening is set downstream from the juicing body upstream end enough to form a reservoir inside the juicing body when the leading edge is oriented upward.
